(19) United States
(12) Patent Application Publication
(10) Pub. No.: US 2006/0156332 A1
(43) Pub. Date: Jul. 13, 2006

(54) Television signal receiver capable of receiving updated information associated with an emergency alert function

(75) Inventor: Scott Allan Kendall, Westfield, IN (US)

Correspondence Address: THOMSON LICENSING INC., PATENT OPERATIONS, PO BOX 5312, PRINCETON, NJ, 08543-5312, US

(73) Assignee: THOMASON LICENSING S.A., F-92100 BOULOGNE-BILLANCOURT (FR)

(21) Appl. No.: 10/518,998

(22) PCT Filed: Jun. 10, 2003
(86) PCT No.: PCT/US03/18148

§ 371 Date: Dec. 21, 2004

Related U.S. Application Data
(60) Provisional application No. 60/391,909, filed on Jun. 27, 2002.

(51) Int. Cl. H04N 7/10; H04N 7/025; H04N 7/084; H04N 5/445; H04N 7/08; H04N 7/087

(52) U.S. Cl. 725/33; 348/563; 348/473

(57) ABSTRACT

A television signal receiver receives and stores updated information associated with an emergency alert function, such as geographical area information and/or transmission frequency information. According to an exemplary embodiment, the television signal receiver includes a tuner operative to tune a frequency including emergency alert signals indicating an emergency event, and a memory operative to receive and store updated information associated with the emergency alert function.

The present invention generally relates to television signal receivers, and more particularly, to television signal receivers, with or without display device, having an emergency alert function capable of, among other things, receiving and storing updated information associated with the emergency alert function, such as geographical area information and/or transmission frequency information.

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain specialized radios and scanners are capable of receiving emergency alert signals provided by the NWS and NOAA. However, such devices tend to be dedicated to this use, and generally offer consumers little, if any, functionality beyond monitoring these signals. Accordingly, in order to receive advance warning of weather-related emergencies, consumers are required to purchase a separate, dedicated device, which may be cost-prohibitive to some consumers.

Another problem with such devices is their inability to stay up-to-date with changes to the networks they operate within. For example, certain devices employ Specific Area Message Encoding (SAME) technology which utilizes Federal Information Processing Standard (FIPS) location codes to indicate the geographical area(s) affected by an emergency event. As the use of this technology proliferates, new transmitters for emergency alert signals are added and FIPS location codes may change. For example, changes to FIPS location codes may be made as geographical areas change, such as if an existing county is renamed and/or its boundaries are redefined. Unfortunately, current devices for receiving emergency alert signals are unable to keep track of new transmitters, and changed FIPS location codes. As a result, such devices may not operate using the most up-to-date information available, and therefore may not provide consumers an acceptable degree of protection in emergency situations.

Accordingly, there is a need for a device capable of receiving emergency alert signals which avoids the foregoing problems. The present invention addresses these and other issues.

In accordance with an aspect of the present invention, a television signal receiver having an emergency alert function is disclosed. According to an exemplary embodiment, the television signal receiver comprises tuning means for tuning a frequency including emergency alert signals indicating an emergency event, and memory means for receiving and storing updated information associated with the emergency alert function.

In accordance with another aspect of the present invention, a method for controlling a television signal receiver having an emergency alert function is disclosed. According to an exemplary embodiment, the method comprises steps of tuning a frequency including emergency alert signals indicating an emergency event, and receiving and storing updated information associated with the emergency alert function.

The above-mentioned and other features and advantages of this invention, and the manner of attaining them, will become more apparent and the invention will be better understood by reference to the following description of embodiments of the invention taken in conjunction with the accompanying drawings, wherein:

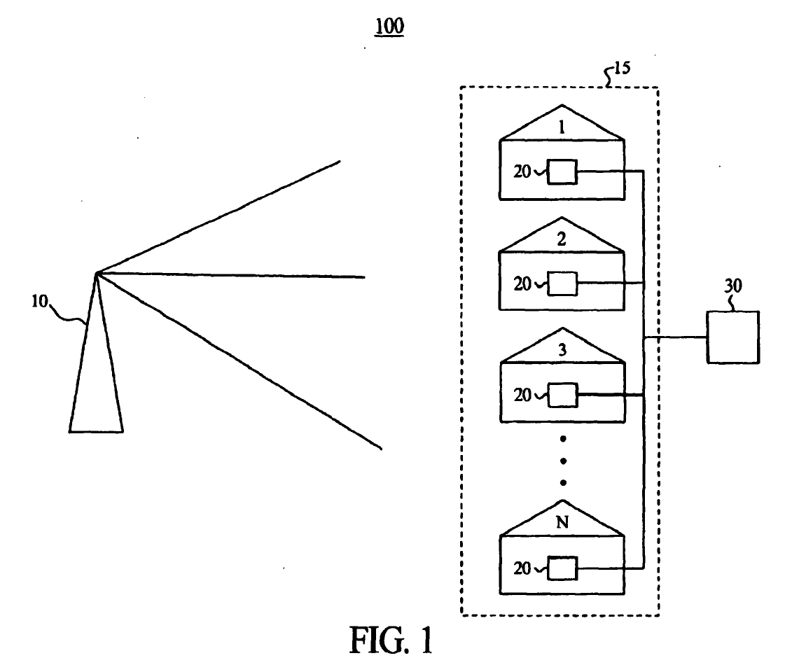

FIG. 1 is an exemplary environment suitable for implementing the present invention;

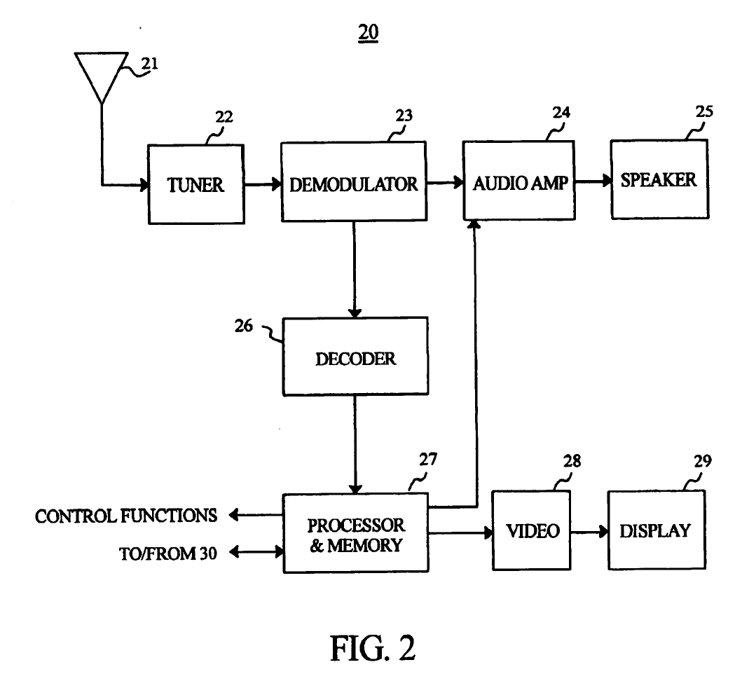

FIG. 2 is a block diagram of a television signal receiver according to an exemplary embodiment of the present invention; and

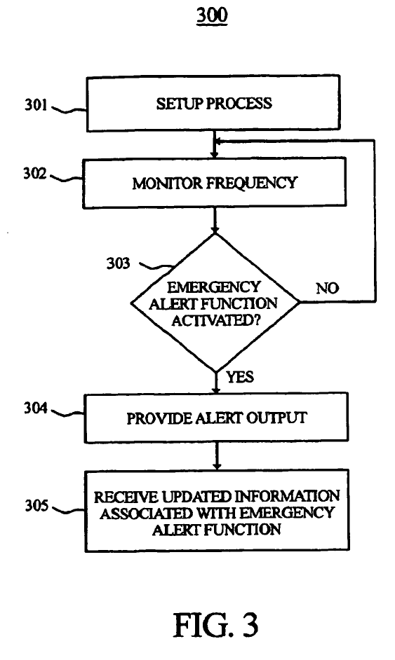

FIG. 3 is a flowchart illustrating exemplary steps according to the present invention.

The exemplifications set out herein illustrate preferred embodiments of the invention, and such exemplifications are not to be construed as limiting the scope of the invention in any manner.

Referring now to the drawings, and more particularly to FIG. 1, an exemplary environment 100 suitable for implementing the present invention is shown. In FIG. 1, environment 100 comprises signal transmission means such as signal transmission source 10, dwelling means such as dwelling units 15 (i.e., 1, 2, 3 . . . N, where N may be any positive integer), signal receiving means such as television signal receivers 20, and information source means such as server(s) 30.

In FIG. 1, dwelling units 15 may represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal receiver 20 having an emergency alert function. According to the present invention, the emergency alert function enables television signal receiver 20 to receive emergency alert signals and provide one or more alert outputs to notify individuals of an emergency event. As will be discussed later herein, television signal receiver 20 is also capable of receiving updated information associated with the emergency alert function, such as geographical area information and/or transmission frequency information, which enables the emergency alert function to be performed with the most up-to-date information available.

According to an exemplary embodiment, signal transmission source 10 transmits signals including emergency alert signals which may be received by each television signal receiver 20. The emergency alert signals may be provided from an authority such as the NWS, or other authorities such as governmental entities or the like. In response to the emergency alert signals, each television signal receiver 20 may provide one or more alert outputs to thereby notify individuals of the emergency event. Signal transmission source 10 may transmit such emergency alert signals to television signal receivers 20 via any wired or wireless link such as, but not limited to, terrestrial, cable, satellite, fiber optic, digital subscriber line (DSL), and/or any other type of broadcast and/or multicast means.

Server(s) 30 may represent one or more websites such as websites from authorities such as the NWS and/or NOAA, and/or other sources of information. According to an exemplary embodiment, server(s) 30 are operative to provide television signal receivers 20 with updated information associated with the emergency alert function. Server(s) 30 may be operatively connected to television signal receivers 20 via any wired and/or wireless link, such as the ones previously referred to herein.

Referring to FIG. 2, a block diagram of an exemplary embodiment of television signal receiver 20 of FIG. 1 is shown. In FIG. 2, television signal receiver 20 comprises signal receiving means such as signal receiving element 21, tuning means such as tuner 22, demodulation means such as demodulator 23, audio amplification means such as audio amplifier 24, audio output means such as speaker 25, decoding means such as decoder 26, processing means and memory means such as processor and memory 27, video processing means such as video processor 28, and visual output means such as display 29. Some of the foregoing elements may for example be embodied using integrated circuits (ICs). For clarity of description, certain conventional elements of television signal receiver 20 may not be shown in FIG. 2.

Signal receiving element 21 is operative to receive signals including audio and/or video signals from signal sources, such as signal transmission source 10 in FIG. 1. According to an exemplary embodiment, received audio signals may include digitally encoded emergency alert signals. Signal receiving element 21 may be embodied as any signal receiving element such as an antenna, input terminal or other element.

Tuner 22 is operative to tune signals including audio and/or video signals. According to an exemplary embodiment, tuner 22 is capable of tuning audio signals on at least the following designated NWS frequencies: 162.400 MHz, 162.425 MHz, 162.450 MHz, 162.475 MHz, 162.500 MHz, 162.525 MHz and 162.550 MHz. Other frequencies may also be tuned. As previously indicated herein, such audio signals may include digitally encoded emergency alert signals.

Demodulator 23 is operative to demodulate signals provided from tuner 22. According to an exemplary embodiment, demodulator 23 demodulates audio signals to thereby generate demodulated audio signals representing audio content such as an NWS audio message, a warning alert tone and/or other audio content. Audio amplifier 24 is operative to amplify the audio signals output from demodulator 23 responsive to a control signal provided from processor 27. Speaker 25 is operative to aurally output the amplified audio signals provided from audio amplifier 24.

Decoder 26 is operative to decode signals including audio and/or video signals. According to an exemplary embodiment, decoder 26 decodes audio signals provided from demodulator 23 to thereby extract digitally encoded frequency shift keyed (FSK) signals, which represent emergency alert signals indicating an emergency event. According to this exemplary embodiment, the emergency alert signals include data comprising SAME data associated with the emergency event. SAME data comprises a digital code representing information such as the specific geographical area affected by the emergency event, the type of emergency event (e.g., tornado, toxic chemical spill, radiation leak, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 27 are operative to perform various processing and data storage functions of television signal receiver 20. According to an exemplary embodiment, processor 27 receives the emergency alert signals from decoder 26 and determines whether the emergency alert function of television signal receiver 20 is activated based on data included in the emergency alert signals. According to this exemplary embodiment, processor 27 compares data in the emergency alert signals to user setup data stored in memory 27 to determine whether the emergency alert function is activated. As will be described later herein, a setup process for the emergency alert function of television signal receiver 20 allows a user to select items such as an applicable geographical area(s), and type(s) of emergency events (e.g., tornado, toxic chemical spill, radiation leak, civil emergency, etc.) which activate the emergency alert function.

When the emergency alert function of television signal receiver 20 is activated, processor 27 outputs one or more control signals which enable various operations. According to an exemplary embodiment, such control signals enable one or more alert outputs (e.g., aural and/or visual) to thereby notify individuals of the emergency event. Such control signals may also enable a connection between television signal receiver 20 and a website hosted by server(s) 30. In this manner, television signal receiver 20 may receive from server(s) 30 updated information associated with the emergency alert function, such as geographical area information and/or transmission frequency information. Such control signals may also enable other operations of television signal receiver 20, such as causing it to be switched from an off/standby mode to an on mode. Processor 27 is also operative to enable a browser feature of television signal receiver 20 which allows users to access networks such as the internet. Memory 27 may store data (e.g., bitmapped images, etc.) which enables the browser feature.

Video processor 28 is operative to process signals including video signals. According to an exemplary embodiment, such video signals may include embedded messages such as NWS text messages and/or other messages that provide details regarding emergency events. Video processor 28 may include closed caption circuitry which enables closed caption displays. Display 29 is operative to provide visual displays corresponding to processed signals provided from video processor 28. According to an exemplary embodiment, display 29 may provide visual displays including the aforementioned messages that provide details regarding emergency events.

Turning now to FIG. 3, a flowchart 300 illustrating exemplary steps according to the present invention is shown. For purposes of example and explanation, the steps of FIG. 3 will be described with reference to television signal receiver 20 of FIG. 2. The steps of FIG. 3 are merely exemplary, and are not intended to limit the present invention in any manner.

At step 301, a setup process for the emergency alert function of television signal receiver 20 is performed. According to an exemplary embodiment, a user performs this setup process by providing inputs to television signal receiver 20 (e.g., using a remote control device not shown) responsive to an on-screen menu displayed via display 29. Such an on-screen menu may for example be part of an electronic program guide (EPG) function of television signal receiver 20. According to an exemplary embodiment, the user may select at least the following items during the setup process at step 301:

A. Enable/Disable—The user may select whether to enable or disable the emergency alert function.

B. Frequency Selection—The user may select the monitoring frequency to tune to in order to receive emergency alert signals. For example, the user may select a frequency such as one of the following NWS transmission frequencies: 162.400 MHz, 162.425 MHz, 162.450 MHz, 162.475 MHz, 162.500 MHz, 162.525 MHz and 162.550 MHz.

C. Event Types—The user may select one or more types of emergency events which activate the emergency alert function. For example, the user may designate that events such as civil emergencies, acts of war, and/or tornado warnings activate the emergency alert function, but that events such as thunderstorm warnings do not, etc. The user may also select whether the conventional warning audio tone provided by the NWS and/or other alert mechanism activates the emergency alert function. According to the present invention, different severity or alert levels (e.g., advisory, watch, warning, etc.) may represent different “events.” For example, a thunderstorm watch may be considered a different event from a thunderstorm warning.

D. Geographical Areas—The user may select one or more geographical areas of interest. For example, the user may select a particular continent, country, region, state, area code, zip code, city, county, municipality, subdivision, and/or other definable geographical area.

E. Alert Outputs—The user may select one or more alert outputs to be provided when the emergency alert function is activated. For example, the user may select to aurally output a warning tone and/or an NWS audio message, and the desired volume of each. The user may also select to display an NWS text message (e.g., as a closed caption message) and/or to tune television signal receiver 20 to a specific channel. Other types of alert outputs may also be provided according to the present invention.

F. Updated Information Source—The user may select a source for providing updated information associated with the emergency alert function, such as geographical area information and/or transmission frequency information. For example, the user may designate a website (e.g., NWS or NOAA website) which television signal receiver 20 automatically connects to when the emergency alert function is activated. The user may then interact with the website and thereby cause updated information associated with the emergency alert function to be downloaded and stored in television signal receiver 20. As will be explained later herein, the source (e.g., website) that provides such updated information may also provide information regarding an emergency event. According to an exemplary embodiment, the user may setup television signal receiver 20 to automatically connect to a particular website based on the particular event type indicated by the emergency alert signals. For example, if the event is a tornado warning, processor 27 may detect this event indication by the emergency alert signals and cause television signal receiver 20 to automatically connect to a particular website that provides information regarding tornados.

According to the present invention, other menu selections may also be provided at step 301 and/or some of the menu selections described above may be omitted. Data corresponding to the user's selections during the setup process of step 301 is stored in memory 27.

At step 302, television signal receiver 20 monitors the frequency selected by the user during the setup process of step 301 (i.e., item B) for emergency alert signals. According to an exemplary embodiment, tuner 22 monitors the selected frequency and thereby receives incoming emergency alert signals. According to the present invention, television signal receiver 20 is capable of monitoring a frequency and receiving emergency alert signals during all modes of operation, including for example when television signal receiver 20 is turned on, turned off, and/or during playback of recorded audio and/or video content.

At step 303, a determination is made as to whether the emergency alert function of television signal receiver 20 is activated. According to an exemplary embodiment, processor 27 makes this determination by comparing data included in the incoming emergency alert signals to data stored in memory 27 from the setup process of step 301. As previously indicated herein, the emergency alert signals may include data such as SAME data which represents information including the type of emergency event (e.g., tornado, toxic chemical spill, radiation leak, civil emergency, etc.) and the specific geographical area(s) affected by the emergency event. According to an exemplary embodiment, processor 27 compares this SAME data to the corresponding data from the setup process of step 301 (i.e., items C and D) stored in memory 27 to thereby determine whether the emergency alert function is activated. In this manner, the emergency alert function of television signal receiver 20 is activated only when the emergency event indicated by the emergency alert signals corresponds to the geographical area(s) and/or event type(s) designated by the user at step 301.

If the determination at step 303 is negative, process flow loops back to step 302 where tuner 22 continues to monitor the selected frequency. Alternatively, if the determination at step 303 is positive, process flow advances to step 304 where television signal receiver 20 provides one or more alert outputs to thereby notify individuals of the emergency event.

According to an exemplary embodiment, processor 27 enables the one or more alert outputs at step 304 in accordance with the user's selections during the setup process of step 301 (i.e., item E), and such alert outputs may be aural and/or visual in nature. For example, aural outputs such as a warning tone and/or an NWS audio message may be provided at step 304 via speaker 25, and the volume of such aural outputs may be controlled in accordance with the volume level set by the user during the setup process of step 301.

Visual outputs may also be provided at step 304 via display 29 to notify individuals of the emergency event. According to an exemplary embodiment, an auxiliary information display such as an NWS text message (e.g., as a closed caption display) and/or a video output from a specific channel may be provided at step 304 via display 29 under the control of processor 27. Other types of aural and/or visual alert outputs than those expressly described herein may also be provided at step 304 according to the present invention.

At step 305, television signal receiver 20 receives updated information associated with the emergency alert function, such as but not limited to, geographical area information and/or transmission frequency information, and stores the updated information in memory 27. Such updated information enables the emergency alert function of television signal receiver 20 to be performed with the most up-to-date information available. According to the present invention, such updated information may be provided to television signal receiver 20 in various different ways which will be described below.

According to one exemplary embodiment, processor 27 automatically enables a connection between television signal receiver 20 and a website (e.g., server(s) 30) designated by the user during the setup process of step 301 (i.e., item F) whenever the emergency alert function is activated. For example, if the user designates the NOAA website as a source of updated information during the setup process of step 301, then processor 27 automatically enables a connection between television signal receiver 20 and the NOAA website whenever the emergency alert function is activated. The user may then interact with the designated website through the browser and thereby cause updated information associated with the emergency alert function to be downloaded to television signal receiver 20 and stored in memory 27. For example, the website may include maps that enable the user to select one or more geographical areas of interest, and cause updated information, such as new FIPS location codes and/or new transmission frequencies, corresponding to those areas to be downloaded to television signal receiver 20.

According to another exemplary embodiment, processor 27 automatically enables a connection between television signal receiver 20 and a website (e.g., server(s) 30) based on the particular event type indicated by the emergency alert signals. As previously indicated herein, the user may setup television signal receiver 20 at step 301 (i.e., item F) to automatically connect to a particular website based on the particular event type indicated by the emergency alert signals. For example, if the event is a tornado warning, processor 27 may detect this event indication by the emergency alert signals and cause television signal receiver 20 to automatically connect to a particular website that provides information regarding tornados. The user may then interact with the website through the browser and thereby cause updated information associated with the emergency alert function to be downloaded to television signal receiver 20 and stored in memory 27. For example, the website may include maps that enable the user to select one or more geographical areas of interest, and cause updated information, such as new FIPS location codes and/or new transmission frequencies, corresponding to those areas to be downloaded to television signal receiver 20.

According to still another exemplary embodiment, the emergency alert signals which activate the emergency alert function may additionally include hyperlink data which enables a user to access one or more websites (e.g., server(s) 30) that provide such updated information. For example, the user may access the one or more websites via the hyperlink data and thereby cause updated information associated with the emergency alert function to be downloaded to television signal receiver 20 and stored in memory 27. As previously indicated herein, websites may for example include maps that enable the user to select one or more geographical areas of interest, and thereby cause updated information, such as new FIPS location codes and/or new transmission frequencies, corresponding to those areas to be downloaded to television signal receiver 20.

According to yet another exemplary embodiment, updated information associated with the emergency alert function may be provided to television signal receiver 20 independently from activation of the emergency alert function. For example, updated information, such as new FIPS location codes and/or new transmission frequencies, corresponding to the user's area, may be automatically downloaded to television signal receiver 20 from server(s) 30 on a periodic basis (e.g., weekly, monthly, etc.) regardless of whether the emergency alert function has been activated.

According to the present invention, any of the foregoing embodiments or other embodiments may be used at step 305 to receive updated information associated with the emergency alert function of television signal receiver 20. As previously indicated herein, the website(s) that provide such updated information may also provide information regarding an emergency event. For example, website(s) such as the NWS or NOAA websites may provide messages regarding the emergency event. Information regarding national events and/or homeland security may also be provided in certain instances. In this manner, television signal receiver 20 may receive information regarding an emergency event via the broadcast emergency alert signals and/or via a web cast from a website. Television signal receiver 20 may be also be configured to automatically select between such sources of information based on which source provides the best signal reception.

According to the present invention, once the updated information is received by television signal receiver 20, it may then be used to setup or re-configure the emergency alert function, such as through the setup process of step 301. For example, after television signal receiver 20 receives updated information at step 305, the user may again perform the setup process of step 301 to select one or more geographical areas of interest (i.e., item D) having new and/or changed FIPS location codes. The user may also for example select a new transmission frequency to tune in order to receive emergency alert signals (i.e., item B) when new transmitters are available in the user's area. In this manner, the emergency alert function of television signal receiver 20 may be performed with the most up-to-date information available, which thereby provides users with a high degree of protection in emergency situations.

As described herein, the present invention provides a technique for providing updated information for television signal receivers having an emergency alert function. The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, video cassette recorders (VCRs), digital versatile disk (DVD) players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A television signal receiver having an emergency alert function, comprising:
a tuner operative to tune a frequency including emergency alert signals indicating an emergency event; and
a memory operative to receive and store updated information associated with the emergency alert function.

2. The television signal receiver of claim 1, wherein the updated information comprises geographical area information.

3. The television signal receiver of claim 2, wherein the geographical area information comprises a FIPS location code.

4. The television signal receiver of claim 1, wherein the updated information comprises transmission frequency information.

5. The television signal receiver of claim 1, wherein the updated information is provided via a website.

6. The television signal receiver of claim 5, further comprising a processor operative to automatically enable a connection to the website responsive to the emergency alert signals.

7. The television signal receiver of claim 6, wherein the processor is further operative to enable an alert output responsive to the emergency alert signals.

8. The television signal receiver of claim 5, wherein the emergency alert signals include hyperlink data that enables access to the website.

9. The television signal receiver of claim 1, wherein the updated information is automatically provided on a periodic basis.

10. The television signal receiver of claim 1, wherein the updated information is used to setup the emergency alert function.

11. A television signal receiver having an emergency alert function, comprising:
tuning means for tuning a frequency including emergency alert signals indicating an emergency event; and
memory means for receiving and storing updated information associated with the emergency alert function.

12. The television signal receiver of claim 11, wherein the updated information comprises geographical area information.

13. The television signal receiver of claim 12, wherein the geographical area information comprises a FIPS location code.

14. The television signal receiver of claim 11, wherein the updated information comprises transmission frequency information.

15. The television signal receiver of claim 11, wherein the updated information is provided via a website.

16. The television signal receiver of claim 15, further comprising processing means for automatically enabling a connection to the website responsive to the emergency alert signals.

17. The television signal receiver of claim 16, wherein the processing means further enables an alert output responsive to the emergency alert signals.

18. The television signal receiver of claim 15, wherein the emergency alert signals include hyperlink data that enables access to the website.

19. The television signal receiver of claim 11, wherein the updated information is automatically provided on a periodic basis.

20. The television signal receiver of claim 11, wherein the updated information is used to setup the emergency alert function.

21. A method for controlling a television signal receiver having an emergency alert function, comprising:
tuning a frequency including emergency alert signals indicating an emergency event; and
receiving and storing updated information associated with the emergency alert function.

22. The method of claim 21, wherein the updated information comprises geographical area information.

23. The method of claim 22, wherein the geographical area information comprises a FIPS location code.

24. The method of claim 21, wherein the updated information comprises transmission frequency information.

25. The method of claim 21, wherein the updated information is provided via a website.

26. The method of claim 25, wherein the television signal receiver is automatically connected to the website responsive to the emergency alert signals.

27. The method of claim 26, further comprised of providing an alert output responsive to the emergency alert signals.

28. The method of claim 25, wherein the emergency alert signals include hyperlink data that enables access to the website.

29. The method of claim 21, wherein the updated information is automatically provided on a periodic basis.

30. The method of claim 21, further comprised of enabling use of the updated information to setup the emergency alert function.
